(19) United States
(12) Patent Application Publication
(10) Pub. No.: US 2021/0166561 A1
(43) Pub. Date: Jun. 3, 2021

(54) ROADSIDE DEVICE, VEHICLE-MOUNTED EQUIPMENT, ROAD-TO-VEHICLE COMMUNICATION SYSTEM, ROAD-TO-VEHICLE COMMUNICATION METHOD, AND PROGRAM

(71) Applicant: MITSUBISHI HEAVY INDUSTRIES MACHINERY SYSTEM, LTD., Hyogo (JP)

(72) Inventors: Taizo YAMAGUCHI, Tokyo (JP); Saku IEUJI, Tokyo (JP)

(21) Appl. No.: 17/046,727

(22) PCT Filed: Apr. 10, 2018
(86) PCT No.: PCT/JP2018/015028

§ 371 Date: Oct. 9, 2020

(51) Int. Cl. G08G 1/123; G08G 1/017; G08G 1/01; H04W 4/44

(52) U.S. Cl. CPC G08G 1/123; G08G 1/017; H04W 4/44; G08G 1/0112; G08G 1/0116

(57) ABSTRACT

A roadside device for communicating with vehicle-mounted equipment on a vehicle, via a roadside antenna, is provided with: a history reception unit for receiving from the vehicle-mounted equipment both roadside device identification information capable of specifying the roadside device that the vehicle-mounted equipment communicates with, and communication history information, recorded in association with radio wave intensities used in the communication with the roadside device; and a connection processing unit which continues the communication with the vehicle-mounted equipment when a first radio wave intensity associated with the roadside device identification information of the own roadside device is the greatest among the plurality of radio wave intensities included in the communication history information, and cuts off the communication with the vehicle-mounted equipment when the first radio wave intensity is less than a second radio wave intensity associated with the roadside device identification information of another roadside device.

### TECHNICAL FIELD

The present invention relates to a roadside device, a vehicle-mounted equipment, a road-to-vehicle communication system, a road-to-vehicle communication method, and a program.

### BACKGROUND ART

As a system for collecting usage fees from vehicles on a toll road, a parking lot, and the like, an electronic toll collection system (ETC (registered trademark); also referred to as an “electronic toll-collection system”) is known. In such a system, a roadside device installed in each of lanes and a vehicle-mounted equipment (an on-board unit) mounted in a vehicle performs wireless communication (road-to-vehicle communication) through a roadside antenna and transmits/receives various kinds of information required for a toll collection process. In addition, in order to inhibit erroneous communication with an on-board unit positioned in another lane that is positioned adjacent thereto (hereinafter, also referred to as an “adjacent lane”), a structure in which a roadside device determines that an on-board unit is positioned in a lane in which an own roadside device is installed (hereinafter, also referred to as an “own lane”) in a case in which radio waves from the on-board unit have an intensity equal to or higher than a predetermined radio wave intensity has been considered (for example, see Patent Document 1).

### CITATION LIST

### Patent Literature

[Patent Document 1]

Japanese Unexamined Patent Application, First Publication No. 2012-128649

### SUMMARY OF INVENTION

### Technical Problem

At a place in which a plurality of lanes are disposed, there are cases in which radio waves used for road-to-vehicle communication are reflected by structures (walls, roofs, and the like) in the vicinity of the lanes or vehicles and the like. In a case in which radio waves from an on-board unit positioned in an adjacent lane have an intensity equal to or higher than a predetermined radio wave intensity, there is a possibility that a roadside device will erroneously determine that an on-board unit in an adjacent lane is an on-board unit, which is to be communicated with, present in an own lane and start road-to-vehicle communication. For this reason, there is demand for a structure for further inhibiting erroneous communication between a roadside device and an on-board unit positioned in an adjacent lane.

### Solution to Problem

In order to solve the problems described above, the present invention employs the following means.

According to a first aspect of the present invention, a roadside device (3) that is configured to communicate with an on-board unit (2) (a vehicle-mounted equipment) mounted in a vehicle traveling in a lane through a roadside antenna (4) installed to have the lane as a communication range includes: a history receiving unit (300) configured to receive communication history information in which roadside device identification information that can be used for identifying a roadside device (3) with which the on-board unit (2) has communicated and a radio wave intensity in communication with the roadside device (3) are recorded in association with each other from the on-board unit (2); and a connection processing unit (301) configured to continue communication with the on-board unit (2) in a case in which a first radio wave intensity associated with the roadside device identification information of an own roadside device (3) is the highest among a plurality of radio wave intensities included in the communication history information and disconnect the communication with the on-board unit (2) in a case in which the first radio wave intensity is lower than a second radio wave intensity associated with the roadside device identification information of another roadside device (3).

Generally, the radio wave intensity becomes higher as the distance between a roadside antenna and an on-board unit becomes shorter. Thus, the roadside device can determine that the likelihood of the on-board unit being positioned in an own lane is high in a case in which the first radio wave intensity of an own roadside device is the highest among radio wave intensities included in the communication history information and that the likelihood of the on-board unit being positioned in an adjacent lane is high in a case in which the first radio wave intensity of an own roadside device is lower than the second radio wave intensity of another roadside device. For this reason, since the roadside device continues communication with the on-board unit only in a case in which there is a high likelihood of the on-board unit being positioned in an own lane, erroneous communication with an on-board unit positioned in an adjacent lane can be inhibited.

Furthermore, since the roadside device disconnects communication with the on-board unit in a case in which there is a high likelihood of the on-board unit being positioned in an adjacent lane, this leads to reconnection of communication between the on-board unit and another roadside device.

According to a second aspect of the present invention, in the roadside device (3) according to the first aspect, the connection processing unit (301) is configured to determine whether to continue or disconnect the communication with the on-board unit (2) on the basis of the radio wave intensity included in a target period from a current time to a predetermined prior time among a plurality of radio wave intensities included in the communication history information.

With such a configuration, the roadside device can exclude past radio wave intensities before the on-board unit arrived at a communication range for the roadside device from determination target data, and therefore, the accuracy of determination of whether or not the on-board unit is positioned in an own lane can be improved.

According to a third aspect of the present invention, in the roadside device (3) according to the first or second aspect, the connection processing unit (301) is configured to disconnect communication with the on-board unit (2) in a case in which a predetermined time has elapsed from start of the communication with the on-board unit (2).

For example, in a case in which only the first radio wave intensity associated with the roadside device identification information of an own roadside device is recorded in the communication history information, there is a likelihood of the roadside device erroneously continuing communication with an on-board unit positioned in an adjacent lane. However, the connection processing unit 301 described in the aspect described above can provide a chance for the on-board unit to be connected to another roadside device by temporarily disconnecting communication after the predetermined time elapses from the start of communication. In this way, the roadside device can inhibit continuation of erroneous communication with the on-board unit.

According to a fourth aspect of the present invention, an on-board unit (2) that is mounted in a vehicle and is configured to communicate with a roadside device (3) through a roadside antenna (4) installed to have a lane as a communication range includes: a signal receiving unit (200) configured to receive a signal from the roadside device (3); a history storing section (220) configured to record communication history information in which roadside device identification information of the roadside device (3) included in the signal and a radio wave intensity of the signal are associated with each other; and a history transmitting unit (201) configured to transmit the communication history information to the roadside device (3).

With such a configuration, the on-board unit can provide the communication history information that can enable determination of whether or not the on-board unit is positioned in a lane that is a communication range of the roadside device with a high accuracy for the roadside device. In this way, erroneous communication between the roadside device and the on-board unit can be inhibited.

According to a fifth aspect of the present invention, a road-to-vehicle communication system (1) includes: the roadside device (3) described in any one of the first to third aspects; and the on-board unit (2) described in the fourth aspect.

According to a sixth aspect of the present invention, a road-to-vehicle method for communication with an on-board unit (2) mounted in a vehicle traveling in a lane through a roadside antenna (4) installed to have the lane as a communication range, includes: a step of receiving communication history information in which roadside device identification information that can be used for identifying a roadside device (3) with which the on-board unit (2) has communicated and a radio wave intensity in communication with the roadside device (3) are recorded in association with each other from the on-board unit (2); and a step of continuing communication with the on-board unit (2) in a case in which a first radio wave intensity associated with the roadside device identification information of an own roadside device (3) is the highest among a plurality of radio wave intensities included in the communication history information; and a step of disconnecting the communication with the on-board unit (2) in a case in which the first radio wave intensity is lower than a second radio wave intensity associated with the roadside device identification information of another roadside device (3) among the plurality of radio wave intensities included in the communication history information.

According to a seventh aspect of the present invention, there is a program causing a computer of a roadside device (3), which is configured to communicate with an on-board unit (2) mounted in a vehicle traveling in a lane through a roadside antenna (4) installed to have the lane as a communication range, to function, the program causing the computer to execute: a step of receiving communication history information in which roadside device identification information that can be used for identifying a roadside device (3) with which the on-board unit (2) has communicated and a radio wave intensity in communication with the roadside device (3) are recorded in association with each other from the on-board unit (2); a step of continuing communication with the on-board unit (2) in a case in which a first radio wave intensity associated with the roadside device identification information of an own roadside device (3) is the highest among a plurality of radio wave intensities included in the communication history information; and a step of disconnecting the communication with the on-board unit (2) in a case in which the first radio wave intensity is lower than a second radio wave intensity associated with the roadside device identification information of the other roadside device (3) among the plurality of radio wave intensities included in the communication history information.

According to an eighth aspect of the present invention, there is a program causing a computer of an on-board unit (2), which is mounted in a vehicle and is configured to communicate with a roadside device (3) through a roadside antenna (4) installed to have a lane as a communication range, to function, the program causing the computer to execute: a step of receiving a signal from the roadside device (3); a step of recording communication history information in which roadside device identification information of the roadside device (3) included in the signal and the radio wave intensity of the signal are associated with each other; and a step of transmitting the communication history information.

### Advantageous Effects of Invention

According to the aspects described above, erroneous communication between a roadside device and an on-board unit positioned in an adjacent lane can be inhibited.

### BRIEF DESCRIPTION OF DRAWINGS

FIG. 1 is a diagram showing the entire configuration of a road-to-vehicle communication system according to an embodiment of the present invention.

FIG. 2 is a diagram showing the functional configuration of a road-to-vehicle communication system according to an embodiment of the present invention.

FIG. 3 is a diagram showing an example of communication history information according to an embodiment of the present invention.

FIG. 4 is a diagram showing an example of a road-to-vehicle communication process according to an embodiment of the present invention.

FIG. 5 is a diagram showing functions of a road-to-vehicle communication system according to an embodiment of the present invention.

FIG. 6 is a diagram showing an example of the hardware configuration of an on-board unit and a roadside device according to an embodiment of the present invention.

### DESCRIPTION OF EMBODIMENTS

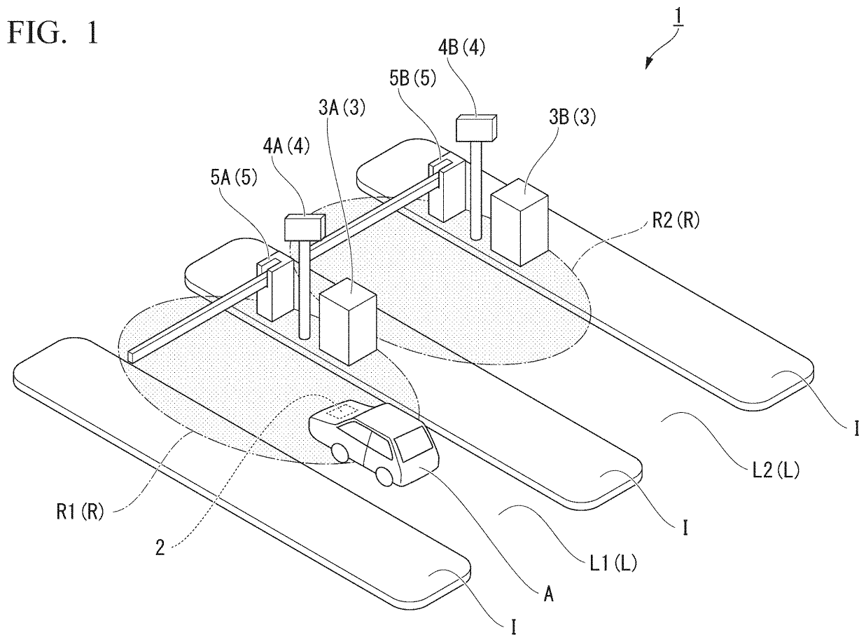

Hereinafter, a road-to-vehicle communication system 1 according to an embodiment of the present invention will be described with reference to FIGS. 1 to 6.

### (Entire Configuration of Road-To-Vehicle Communication System)

FIG. 1 is a diagram showing the entire configuration of a road-to-vehicle communication system according to an embodiment of the present invention.

The road-to-vehicle communication system 1 according to this embodiment, for example, functions as a toll collection system that is disposed at an exit of a parking lot and collects a parking fee from a vehicle A that has arrived at an exit lane (hereinafter, also referred to as a “lane L”) of the parking lot. In another embodiment, the road-to-vehicle communication system 1 may be used as a toll collection system for collecting toll fees for a toll road.

In this embodiment, it is assumed that a plurality of lanes L are disposed in a parking lot. Although an example in which two lanes L1 and L2 are disposed is shown in FIG. 1, the number of lanes is not limited thereto, and three or more lanes L may be disposed.

As shown in FIG. 1, the road-to-vehicle communication system 1 includes an on-board unit 2 (a vehicle-mounted equipment), roadside devices 3, roadside antennas 4, and start controllers 5.

The on-board unit 2 is mounted in the vehicle A and communicates with the roadside device 3 through the roadside antenna 4 to be described below.

The roadside device 3 communicates with the on-board unit 2 mounted in the vehicle A traveling in the lane L through the roadside antenna 4.

One of the roadside devices 3 may be installed on an island I disposed on the road side of the lane L for each lane. For example, in the example shown in FIG. 1, a roadside device 3A is disposed in a lane L1, and a roadside device 3B is disposed in a lane L2.

In addition, the roadside device 3 collects a parking fee for the vehicle A by performing road-to-vehicle communication (hereinafter, also referred to simply as “communication”) with the on-board unit 2 through radio communication.

The roadside antenna 4 sets the lane L as a communication range. In this embodiment, the roadside antenna 4 is disposed on an island disposed on the road side of the lane L for each lane and performs transmission and stopping of the transmission of radio waves used for communicating with the on-board unit 2 positioned within a predetermined communication range R in accordance with control of the roadside device 3. For example, in the example shown in FIG. 1, a roadside antenna 4A is disposed in the lane L1 and communicates with the on-board unit 2 positioned within a communication range R1. In addition, a roadside antenna 4B is disposed in the lane L2 and communicates with the on-board unit 2 positioned within a communication range R2.

The start controller 5 performs an opening operation and a closing operation on a gate in accordance with control of the roadside device 3. For example, the start controller 5 is disposed for the purpose of not allowing the vehicle A to start until a parking fee collection process is completed and the like.

### (Functional Configuration of Road-To-Vehicle Communication System)

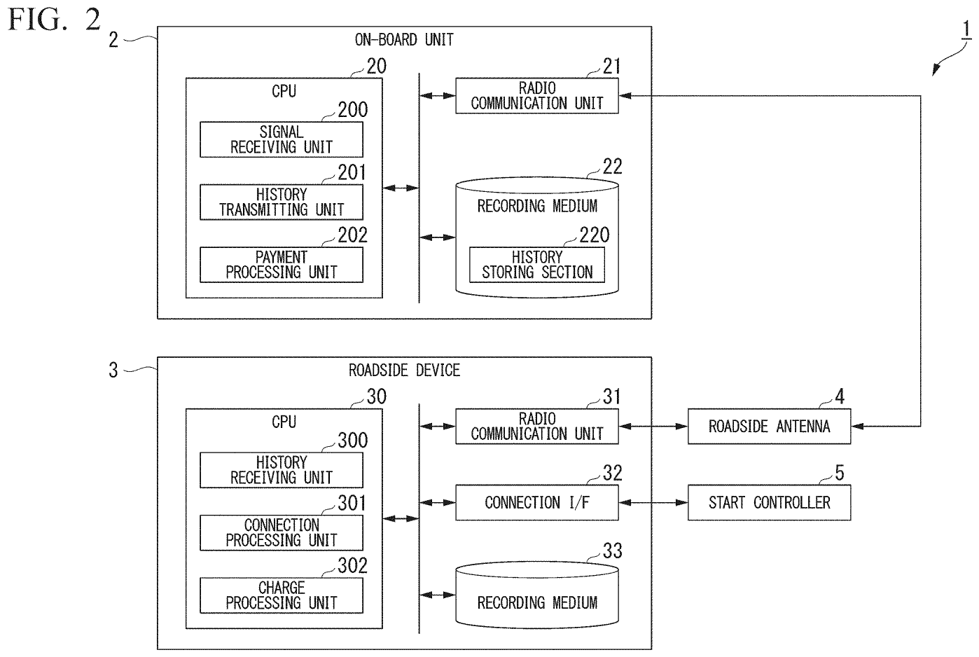

FIG. 2 is a diagram showing the functional configuration of the road-to-vehicle communication system according to an embodiment of the present invention.

As shown in FIG. 2, the on-board unit 2 includes a CPU 20, a radio communication unit 21, and a recording medium 22.

The CPU 20 is a processor that is responsible for an overall operation of the on-board unit 2 and allows functions of a signal receiving unit 200, a history transmitting unit 201 and a payment processing unit 202 to be exhibited by operating in accordance with a predetermined program.

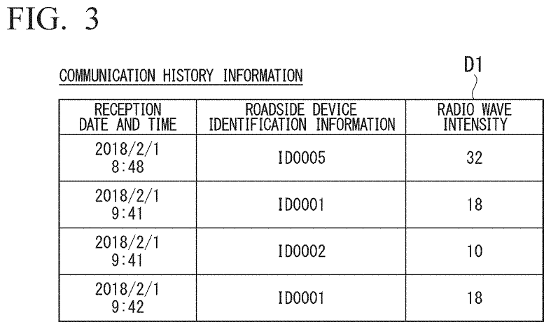

The signal receiving unit 200 receives a signal (a “query signal” to be described below) from the roadside device 3 through the radio communication unit 21. In addition, the signal receiving unit 200 stores “communication history information D1 (FIG. 3)” relating to a roadside device that has performed a communication connection in a history storing section 220 of the recording medium 22 on the basis of a received signal.

FIG. 3 is a diagram showing an example of communication history information according to an embodiment of the present invention.

As shown in FIG. 3, “communication history information D1” is information in which a “reception date and time” at which a signal is received, “roadside device identification information” (to be described below) of the roadside device 3 included in the received signal, and a “radio wave intensity” of the signal are associated with each other.

The history transmitting unit 201 transmits “communication history information D1” to the roadside device 3.

The payment processing unit 202 performs a payment process for a parking fee charged by the roadside device 3.

The radio communication unit 21 allows connection for or disconnects communication with the roadside device 3 through the roadside antenna 4.

More specifically, when a “query signal” is received from the roadside device 3 through the roadside antenna 4, the radio communication unit 21 transmits a “response signal” including “on-board unit identification information” in response to the “query signal”, thereby allowing connection for communication with the roadside device 3.

In addition, “on-board unit identification information” is information that can be used for identifying the on-board unit 2 and, for example, may be a communication ID generated for communication by the radio communication unit 21 or a unique number (an on-board unit ID or the like) of the on-board unit 2 that is recorded in the recording medium 22 in advance.

At this time, the radio communication unit 21 outputs the received “query signal” to the signal receiving unit 200 of the CPU 20, thereby notifying that there is connection for communication with the roadside device 3.

In addition, in a case in which a period, in which any of various signals (information) have not been received from the roadside device 3, continues for a predetermined time or more after start of communication with the roadside device 3, the radio communication unit 21 determines that the communication has been disconnected.

The recording medium 22 has a history storing section 220 in which “communication history information D1” is recorded. In addition, “on-board unit identification information” is recorded in the recording medium 22 in advance.

As shown in FIG. 2, the roadside device 3 includes a CPU 30, a radio communication unit 31, a connection interface (I/F) 32, and a recording medium 33.

The CPU 30 is a processor that is responsible for an overall operation of the roadside device 3 and allows functions of a history receiving unit 300, a connection processing unit 301, and a charge processing unit 302 to be exhibited by operating in accordance with a predetermined program.

The history receiving unit 300 receives “communication history information D1” and “on-board unit identification information” transmitted from the on-board unit 2.

The connection processing unit 301 allows communication with the on-board unit 2 to continue in a case in which a first radio wave intensity associated with “roadside device identification information” of an own roadside device 3 (for example, the roadside device 3A shown in FIG. 1) is the highest among a plurality of “radio wave intensities” included in “communication history information D1”. In addition, the connection processing unit 301 disconnects the communication with the on-board unit 2 in a case in which a first radio wave intensity is lower than a second radio wave intensity associated with “roadside device identification information” of the other roadside device 3 (for example, the roadside device 3B shown in FIG. 1).

The charge processing unit 302 performs a process of charging a parking fee for the vehicle A.

In addition, when the charging process for the vehicle A is completed, the charge processing unit 302 permits starting of the vehicle A by outputting an open instruction to the start controller 5.

The radio communication unit 31 connects or disconnects communication with the on-board unit 2 through the roadside antenna 4. More specifically, the radio communication unit 31 transmits a “query signal” including “roadside device identification information” to the on-board unit 2 positioned within the communication range R of the lane L for every predetermined transmission interval. Then, the radio communication unit 31 connects communication with the on-board unit 2 that returns a “response signal” in response to the “query signal”. Then, the radio communication unit 31 outputs a connection notification of a connection to the on-board unit 2 to the CPU 30.

In addition, the “roadside device identification information” is information that can be used for identifying each of a plurality of roadside devices 3 and, for example, may be a communication ID generated for communication by the radio communication unit 31 or may be a unique number (a serial number or the like) of the roadside device 3 or the roadside antenna 4 that is recorded in the recording medium 33 in advance.

In addition, in a case in which a disconnection instruction is output from the connection processing unit 301 of the CPU 30 after connecting a communication with the on-board unit 2, the radio communication unit 31 disconnects the communication.

The start controller 5 is connected to the connection I/F 32. The connection I/F transmits an opening instruction and a closing instruction to the start controller 5 in accordance with control of the CPU 30.

“Roadside device identification information” is recorded in the recording medium 33 in advance.

### (Processing Flow of Road-To-Vehicle Communication System)

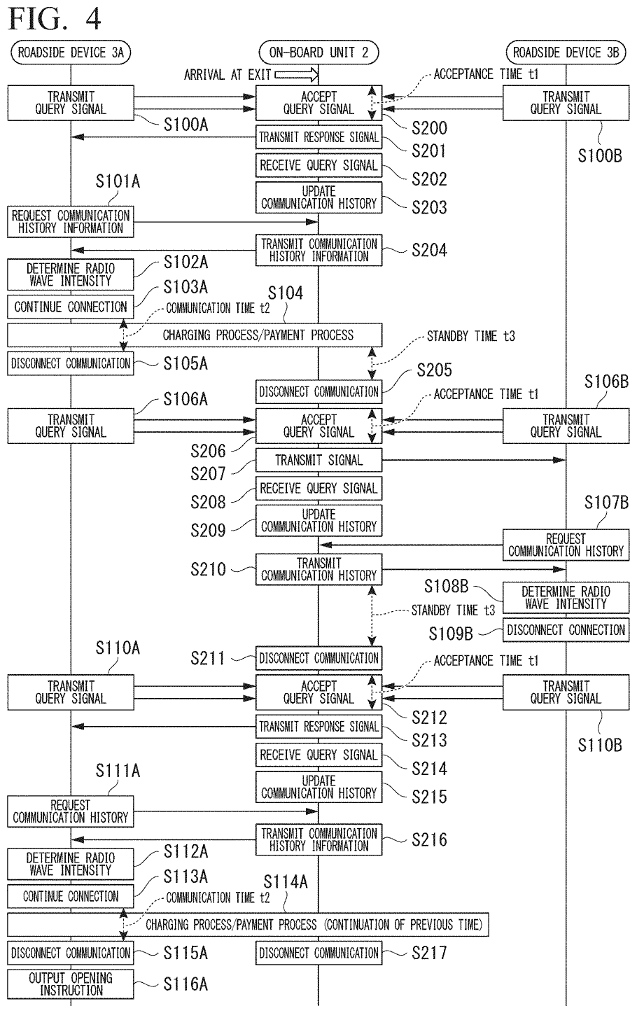

FIG. 4 is a diagram showing an example of a road-to-vehicle communication process according to an embodiment of the present invention.

Hereinafter, an example of the road-to-vehicle communication process performed between the on-board unit 2 and the roadside device 3 will be described with reference to FIG. 4.

Here, as shown in FIG. 1, it is assumed that the roadside device 3A and the roadside antenna 4A are disposed in the lane L1, and the roadside device 3B and the roadside antenna 4B are disposed in the lane L2. In addition, while the vehicle A (the on-board unit 2) is positioned within the communication range R1 of the lane L1, it is assumed that radio waves sent from the roadside antenna 4B are reflected by a structure and the like in the vicinity and arrive at the on-board unit 2 in addition to radio waves sent from the roadside antenna 4A.

First, the radio communication unit 31 of each of the roadside device 3A and the roadside device 3B transmits a “query signal” requesting a response from the on-board unit 2 positioned within the communication range R for every predetermined transmission interval (for example, 10 ms) (Steps S100A and S100B).

At this time, the “roadside device identification information” that can be used for identifying each of the roadside devices 3A and 3B is included in the “query signal”.

When the vehicle A arrives at an exit and enters the communication range R1, the radio communication unit 21 of the on-board unit 2 accepts the “query signal” from the roadside devices 3A and 3B (Step S200).

In Step S200, the radio communication unit 21 continuously accepts the “query signals” of the roadside devices 3A and 3B when a predetermined acceptance time t1 (for example, 50 ms) has elapsed after first reception of the “query signal” from the roadside device 3A or 3B. Then, the radio communication unit 21 transmits a “response signal” including the “on-board unit identification information” in response to the last-received “query signal” within the acceptance time t1 (Step S201).

In the example shown in FIG. 4, it is assumed that the radio communication unit 21 transmits a “response signal” in response to a “query signal” of the roadside device 3A.

In addition, the radio communication unit 21 outputs the received “query signal” to the signal receiving unit 200 of the CPU 20 to notify that communication with the roadside device 3A has been connected. Then, the signal receiving unit 200 receives the “query signal” output from the radio communication unit 21 (Step S202).

When the “query signal” is received, the signal receiving unit 200 stores and updates “communication history information D1” in which “reception date and time” of the “query signal”, “roadside device identification information”, and “radio wave intensity” are associated with each other in the history storing section 220 of the recording medium 22 (Step S203).

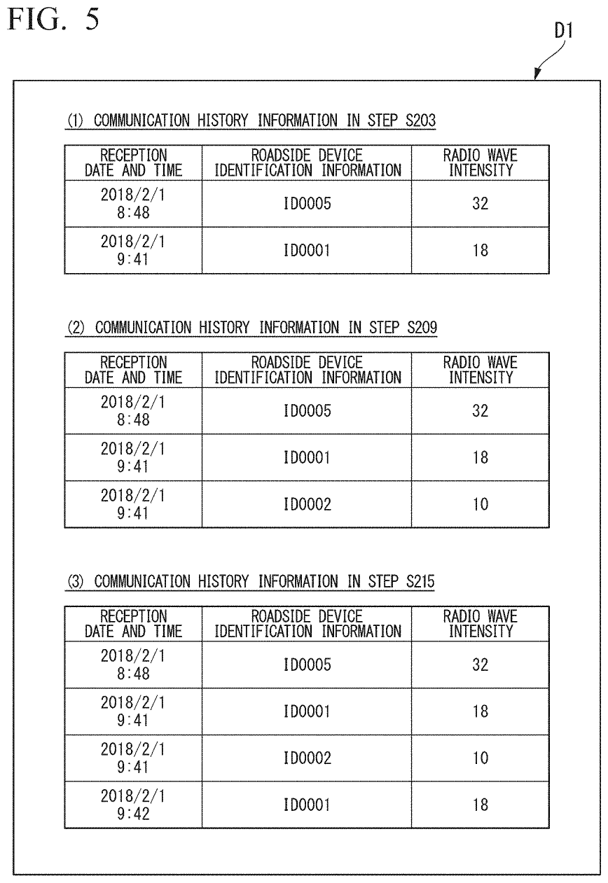

FIG. 5 is a diagram showing functions of a road-to-vehicle communication system according to an embodiment of the present invention.

For example, as shown in “communication history information in Step S203” of (1) of FIG. 5″, it is assumed that the signal receiving unit 200 has recorded “reception date and time: 2018/2/1 9:41”, “roadside device identification information: ID0001”, and “radio wave intensity: 18” as the “communication history information D1” of the roadside device 3A.

Referring back to FIG. 4, when a “response signal” is received from the on-board unit 2, the history receiving unit 300 of the roadside device 3A requests the on-board unit 2 transmit “communication history information D1” (Step S101A).

Then, the history transmitting unit 201 of the on-board unit 2 reads “communication history information D1 ((1) of FIG. 5)” from the history storing section 220 of the recording medium 22 and transmits the read “communication history information D1” to the roadside device 3A (Step S204).

When “communication history information D1” is received from the on-board unit 2, the connection processing unit 301 of the roadside device 3A determines whether or not the radio wave intensity (a first radio wave intensity) of the own roadside device 3A is the highest on the basis of “radio wave intensity” included in “communication history information D1” (Step S102A).

At this time, the connection processing unit 301 performs determination on the basis of “radio wave intensity” included in a target period from the current time (for example, 9:41) to a predetermined prior time (for example, 5 minutes) among a plurality of “radio wave intensities” included in “communication history information D1”. In this way, communication histories before the vehicle A enters the communication range R1 of the lane L1 can be excluded. For example, in the example shown in (1) of FIG. 5, since “radio wave intensity: 32” of “roadside device identification information: ID0005” is not included in the target period, the connection processing unit 301 performs determination with the radio wave intensity excluded. Thus, in the example shown in (1) of FIG. 5, the connection processing unit 301 determines that “radio wave intensity: 18” of “roadside device identification information: ID0001” representing the own roadside device 3A is a maximum.

When the radio wave intensity of the own roadside device 3A is determined to be the maximum, the connection processing unit 301 determines that there is a high likelihood of the on-board unit 2 being positioned in an own lane L1 and continues communication with (connection to) the on-board unit 2 (Step S103A).

Next, the charge processing unit 302 of the roadside device 3A performs the process of charging a parking fee for the vehicle A to the on-board unit 2 (Step S104A).

For example, the charge processing unit 302 calculates a parking fee according to a period during which the vehicle A has used the parking lot and transmits charge information requesting payment of the parking fee to the on-board unit 2. Then, the payment processing unit 202 of the on-board unit 2 performs a payment process of recording the parking fee in an IC card (not shown in the drawing) inserted into the on-board unit 2 on the basis of the charge information received from the roadside device 3, transmitting a credit card number and a valid period used for the payment to the roadside device 3A, and the like.

In addition, when a predetermined communication time t2 (for example, five seconds) has elapsed from the start of communication with on-board unit 2, the connection processing unit 301 of the roadside device 3A outputs an instruction for disconnecting the communication with the on-board unit 2 to the radio communication unit 31. The radio communication unit 31 disconnects communication with the on-board unit 2 in accordance with this disconnection instruction (Step S105A). In addition, the start of communication, for example, may be a timing at which the roadside device 3A receives a “response signal” from the on-board unit 2 or a timing at which the connection processing unit 301 of the roadside device 3A determines to continue communication with the on-board unit 2 in Step S103A.

At this time, in a case in which a charging process for the on-board unit 2 has not been completed, the charge processing unit 302 of the roadside device 3A interrupts the charging process and temporarily records “interrupt information” including “on-board unit identification information” of the on-board unit 2 and details of the execution-ended charging process in the recording medium 33.

When the roadside device 3A disconnects communication with the on-board unit 2, the on-board unit 2 cannot receive various signals (information) relating to the charging process and the payment process from the roadside device 3A. At this time, in a case in which a period in which any of various signals has not been received from the roadside device 3A continues for a predetermined standby time t3 (for example, five seconds) or more, the radio communication unit 21 of the on-board unit 2 determines that communication has been disconnected (Step S205).

When communication is disconnected, the radio communication unit 31 of the roadside device 3A transmits a “query signal” again (Step S106A). In addition, at this time, the roadside device 3B performs transmission of the “query signal” continuously from Step S100B (Step S106B).

The radio communication unit 21 of the on-board unit 2 accepts “query signals” from the roadside devices 3A and 3B until the predetermined acceptance time t1 elapses (Step S206).

Then, the radio communication unit 21 transmits a “response signal” including “on-board unit identification information” in response to a last-received “query signal” within the acceptance time t1 (Step S207).

In the example shown in FIG. 4, it is assumed that the radio communication unit 21 has transmitted a “response signal” in response to the “query signal” of the roadside device 3B.

In addition, the radio communication unit 21 outputs the received “query signal” to the signal receiving unit 200 of the CPU 20 to notify that communication with the roadside device 3B has been connected. Then, the signal receiving unit 200 receives the “query signal” output from the radio communication unit 21 (Step S208).

When the “query signal” is received, the signal receiving unit 200 stores and updates “communication history information D1” in which “reception date and time” of the “query signal”, “roadside device identification information”, and “radio wave intensity” are associated with each other in the history storing section 220 of the recording medium 22 (Step S209).

For example, as shown in “communication history information in Step S209” in (2) of FIG. 5, it is assumed that the signal receiving unit 200 has recorded “reception date and time: 2018/2/1 9:41”, “roadside device identification information: ID0002”, and “radio wave intensity: 10” as “communication history information D1” of the roadside device 3B.

Referring back to FIG. 4, when a “response signal” is received from the on-board unit 2, the history receiving unit 300 of the roadside device 3B requests the on-board unit 2 transmit “communication history information D1” (Step S107B).

Then, the history transmitting unit 201 of the on-board unit 2 reads “communication history information D1 ((2) of FIG. 5)” from the history storing section 220 of the recording medium 22 and transmits the read “communication history information D1” to the roadside device 3B (Step S210).

When “communication history information D1” is received from the on-board unit 2, the connection processing unit 301 of the roadside device 3B determines whether or not a radio wave intensity (a first radio wave intensity) of the own roadside device 3B is the highest on the basis of “radio wave intensity” included in “communication history information D1” (Step S108B).

At this time, the connection processing unit 301, similar to Step S102A, performs determination on the basis of “radio wave intensity” included in a target period from the current time to a predetermined prior time.

In the example shown in (2) of FIG. 5, in “communication history information D1” included in the target period, “radio wave intensity: 10” of “roadside device identification information: ID0002” representing the own roadside device 3B is determined to be lower than “radio wave intensity: 18” of “roadside device identification information: ID0001” representing the other roadside device 3A.

In a case in which it is determined that the radio wave intensity of an the roadside device 3B is not the maximum, the connection processing unit 301 determines that the likelihood of the on-board unit 2 being positioned in an own lane L2 is low (the likelihood of being positioned in an adjacent lane is high) and disconnects communication (connection) with the on-board unit 2 (Step S109B). With these processing, the connection processing unit 301 can quickly end erroneous communication with the on-board unit 2 assumed to be positioned in the adjacent lane.

In a case in which the period in which any of various signals has not been received from the roadside device 3B continues for a predetermined standby time t3 (for example, five seconds) or more, the radio communication unit 21 of the on-board unit 2 determines that communication has been disconnected (Step S211).

When communication is disconnected, the radio communication unit 31 of the roadside device 3A transmits a “query signal” again (Step S106A). In addition, at this time, the roadside device 3B has transmitted the “query signal” continuously from Step S100B (Step S106B).

When communication is disconnected, the radio communication units 31 of the roadside devices 3A and 3B transmit the “query signal” again (Steps S110A and S110B).

The radio communication unit 21 of the on-board unit 2 accepts “query signals” from the roadside devices 3A and 3B until a predetermined acceptance time t1 elapses (Step S212).

Then, the radio communication unit 21 transmits a “response signal” including “on-board unit identification information” in response to the last-received “query signal” within the acceptance time t1 (Step S213).

In the example shown in FIG. 4, it is assumed that the radio communication unit 21 has transmitted a “response signal” in response to the “query signal” of the roadside device 3A.

In addition, the radio communication unit 21 outputs the received “query signal” to the signal receiving unit 200 of the CPU 20 to notify that communication with the roadside device 3A has been connected. Then, the signal receiving unit 200 receives the “query signal” output from the radio communication unit 21 (Step S214).

When the “query signal” is received, the signal receiving unit 200, similar to Step S203, stores and updates “communication history information D1” in the history storing section 220 of the recording medium 22 on the basis of the “query signal” (Step S215).

For example, as represented in “communication history information in Step S215” in (3) of FIG. 5, the signal receiving unit 200 records “reception date and time: 2018/2/1 9:42”, “roadside device identification information: ID0001”, and “radio wave intensity: 18” as “communication history information D1” of the roadside device 3A.

Referring back to FIG. 4, when the “response signal” is received from the on-board unit 2, the history receiving unit 300 of the roadside device 3A requests the on-board unit 2 transmit “communication history information D1” (Step S111A).

Then, the history transmitting unit 201 of the on-board unit 2 reads “communication history information D1 ((3) of FIG. 5)” from the history storing section 220 of the recording medium 22 and transmits the read “communication history information D1” to the roadside device 3A (Step S216).

When “communication history information D1” is received from the on-board unit 2, similar to Step S102A, the connection processing unit 301 of the roadside device 3A determines whether or not a radio wave intensity of the own roadside device 3A (a first radio wave intensity) is the highest (Step S112A).

In the example of (3) of FIG. 5, the connection processing unit 301 determines “radio wave intensity: 18” of “roadside device identification information: ID0001” representing the own roadside device 3A the highest in “communication history information D1” included in the target period.

In a case in which the radio wave intensity of the own roadside device 3A is determined to be a maximum, the connection processing unit 301 determines that the likelihood of the on-board unit 2 being positioned in the own lane L1 is high and continues communication (connection) with the on-board unit 2 (Step S113A).

Next, the charge processing unit 302 of the roadside device 3A performs a process of charging a parking fee for the vehicle A to the on-board unit 2 (Step S114A). At this time, in a case in which “interrupt information” associated with “on-board unit identification information” of the on-board unit 2 is recorded in the recording medium 33, the charging process is restarted on the basis of “interrupt information”.

When the charging process is completed within a communication time t2, the charge processing unit 302 of the roadside device 3A outputs an instruction for disconnecting communication with the on-board unit 2 to the radio communication unit 31. The radio communication unit 31 disconnects communication with the on-board unit 2 in accordance with this disconnection instruction (Step S115A).

At this time, when the payment process is completed, the payment processing unit 202 of the on-board unit 2 may cause the radio communication unit 31 to output an instruction for disconnecting communication with the roadside device 3A. In addition, in a case in which a period in which any of various signals has not been received from the roadside device 3A continues for a predetermined standby time t3 (for example, five seconds) or more, the radio communication unit 31 of the on-board unit 2 may disconnect communication with the roadside device 3A (Step S217).

In addition, the charge processing unit 302 permits start of the vehicle A by outputting an opening instruction to the start controller 5 (Step S116A).

### (Hardware Configuration)

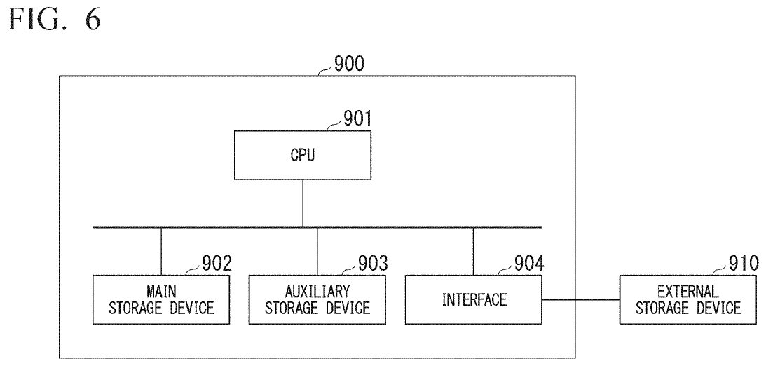

FIG. 6 is a diagram showing an example of the hardware configuration of an on-board unit and a roadside device according to an embodiment of the present invention.

Hereinafter, an example of the hardware configuration of the on-board unit 2 and the roadside device 3 will be described with reference to FIG. 6.

As shown in FIG. 6, a computer 900 includes a CPU 901, a main storage device 902, an auxiliary storage device 903, and an interface 904.

The on-board unit 2 and the roadside device 3 described above are mounted in the computer 900. The operation of each processing unit described above is stored in the auxiliary storage device 903 in the form of a program. The CPU 901 reads the program from the auxiliary storage device 903, expands the read program into the main storage device 902, and executes the processes described above in accordance with the program. In addition, the CPU 901 secures storage areas used for various processes by the on-board unit 2 and the roadside device 3 in the main storage device 902 in accordance with the program. Furthermore, the CPU 901 secures storage areas for storing data during processing in the auxiliary storage device 903 in accordance with the program.

Examples of the auxiliary storage device 903 include a hard disk drive (HDD), a solid-state drive (SSD), a magnetic disk, a magneto-optical disc, a compact disc read only memory (CD-ROM), a digital versatile disc read only memory (DVD-ROM), a semiconductor memory, and the like. The auxiliary storage device 903 may be an internal medium that is directly connected to a bus of the computer 900 or may be an external medium that is connected to the computer 900 through the interface 904 or a communication line. In addition, in a case in which this program is transmitted to the computer 900 using a communication line, the computer 900 that has received the program may expand the program into the main storage device 902 and execute the process. In at least one embodiment, the auxiliary storage device 903 is a recording medium of a non-temporary type.

In addition, the program may be used for realizing some of the functions described above.

Furthermore, the program may be a program that realizes the functions described above in combination with other programs stored in the auxiliary storage device 903 in advance, a so-called differential file (differential program).

### (Operations and Effects)

As described above, the roadside device 3 according to this embodiment is a roadside device 3 that communicates with an on-board unit 2 (a vehicle-mounted equipment) mounted in a vehicle A traveling in a lane L through a roadside antenna 4 installed to have the lane L as a communication range and includes: a history receiving unit 300 configured to receive “communication history information D1” in which “roadside device identification information” that can be used for identifying a roadside device 3 with which the on-board unit 2 has communicated and a “radio wave intensity” in communication with the roadside device 3 are recorded in association with each other from the on-board unit 2; and a connection processing unit 301 configured to continue communication with the on-board unit 2 in a case in which a first radio wave intensity associated with the “roadside device identification information” of an own roadside device 3 (for example, the roadside device 3A shown in FIG. 1) is the highest among a plurality of “radio wave intensities” included in the “communication history information D1” and disconnect the communication with the on-board unit 2 in a case in which the first radio wave intensity is lower than a second radio wave intensity associated with the “roadside device identification information” of the other roadside device 3 (for example, the roadside device 3B shown in FIG. 1).

Generally, the radio wave intensity becomes higher as a distance between a roadside antenna 4 and an on-board unit 2 becomes shorter. Thus, the roadside device 3 can determine that the likelihood of the on-board unit 2 being positioned in an own lane is high in a case in which the first radio wave intensity of the own roadside device 3 is the highest among radio wave intensities included in the “communication history information D1” and that the likelihood of the on-board unit 2 being positioned in an adjacent lane is high in a case in which the first radio wave intensity of the own roadside device 3 is lower than the second radio wave intensity of the other roadside device 3. For this reason, since the roadside device 3 continues communication with the on-board unit 2 only in a case in which there is a high likelihood of the on-board unit 2 being positioned in the own lane, erroneous communication with an on-board unit 2 positioned in an adjacent lane can be inhibited.

Furthermore, since the roadside device 3 disconnects communication with the on-board unit 2 in a case in which there is a high likelihood of the on-board unit 2 being positioned in an adjacent lane, this leads to reconnection of communication between the on-board unit 2 and the other roadside device 3.

In addition, the connection processing unit 301 of the roadside device 3 determines whether to continue or disconnect the communication with the on-board unit 2 on the basis of the “radio wave intensity” included in a target period from a current time to a predetermined prior time among a plurality of “radio wave intensities” included in the “communication history information D1”.

With such a configuration, the roadside device 3 can exclude past “radio wave intensities” before the on-board unit 2 arrives at a communication range R for the roadside device 3 from determination target data, and therefore, the accuracy of determination of whether or not the on-board unit 2 is positioned in the own lane can be improved.

In addition, the connection processing unit 301 of the roadside device 3 disconnects communication with the on-board unit 2 in a case in which a predetermined time t2 has elapsed from start of the communication with the on-board unit 2.

For example, in a case in which only the first radio wave intensity associated with the “roadside device identification information” of the own roadside device 3 is recorded in the “communication history information D1”, there is a likelihood of the roadside device 3 erroneously continuing communication with the on-board unit 2 positioned in an adjacent lane. However, the connection processing unit 301 according to this embodiment can provide a chance for the on-board unit 2 to be connected to the other roadside device by temporarily disconnecting communication after the predetermined time t2 elapses from the start of the communication. In this way, the roadside device 3 can inhibit continuation of erroneous communication with the on-board unit 2.

In addition, the on-board unit 2 according to this embodiment is an on-board unit 2 that is mounted in a vehicle A and communicates with a roadside device 3 through a roadside antenna 4 installed to have a lane L as a communication range including: a signal receiving unit 200 configured to receive a “query signal” from the roadside device 3; a history storing section 220 configured to record “communication history information D1” in which “roadside device identification information” of the roadside device 3 included in the “query signal” and a “radio wave intensity” of the “query signal” are associated with each other; and a history transmitting unit 201 configured to transmit the “communication history information D1” to the roadside device 3.

With such a configuration, the on-board unit 2 can provide the “communication history information D1” that can enable determination of whether or not the on-board unit 2 is positioned in a lane L that is a communication range of the roadside device 3 with a high accuracy for the roadside device 3. In this way, erroneous communication between the on-board unit 2 and the roadside device 3 can be inhibited.

As above, although the embodiment of the present invention has been described in detail, the present invention is not limited thereto, and design changes and the like can be made more or less as long as not departed from the technical idea of the present invention.

For example, a form in which “roadside device identification information” is included in the “query signal” transmitted from the roadside device 3 has been described in the embodiment described above, the present invention is not limited thereto. In another embodiment, only the communication ID generated by the radio communication unit 31 of the roadside device 3 may be included in the “query signal”. In such a case, the history receiving unit 300 of the roadside device 3 sends notification of “roadside device identification information (a serial number or the like)” together when requesting the on-board unit 2 transmit “communication history information D1”.

In addition, similarly, only the communication ID generated by the radio communication unit 21 of the on-board unit 2 may be included in the “response signal” transmitted from the on-board unit 2. In such a case, the history transmitting unit 201 of the on-board unit 2 sends notification of “on-board unit identification information (an on-board unit ID or the like)” together when transmitting “communication history information D1” to the roadside device 3.

### INDUSTRIAL APPLICABILITY

According to the aspects described above, erroneous communication between a roadside device and an on-board unit (a vehicle-mounted device) positioned in an adjacent lane can be inhibited.

### REFERENCE SIGNS LIST

1 Road-to-vehicle communication system

2 On-board unit (vehicle-mounted equipment)

20 CPU

200 Signal receiving unit

201 History transmitting unit

202 Payment processing unit

21 Radio communication unit

22 Recording medium

220 History storing section

3, 3A, 3B Roadside device

30 CPU

300 History receiving unit

301 Connection processing unit

302 Charge processing unit

31 Radio communication unit

33 Recording medium

4, 4A, 4B Roadside antenna

5 Start controller

1. A roadside device that is configured to communicate with a vehicle-mounted equipment mounted in a vehicle traveling in a lane through a roadside antenna installed to have the lane as a communication range, the roadside device comprising:
a history receiving unit configured to receive communication history information in which roadside device identification information that can be used for identifying a roadside device with which the vehicle-mounted equipment has communicated and a radio wave intensity in communication with the roadside device are recorded in association with each other from the vehicle-mounted equipment; and
a connection processing unit configured to continue communication with the vehicle-mounted equipment in a case in which a first radio wave intensity associated with the roadside device identification information of an own roadside device is the highest among a plurality of radio wave intensities included in the communication history information and disconnect the communication with the vehicle-mounted equipment in a case in which the first radio wave intensity is lower than a second radio wave intensity associated with the roadside device identification information of another roadside device.

2. The roadside device according to claim 1, wherein the connection processing unit is configured to determine whether to continue or disconnect the communication with the vehicle-mounted equipment on the basis of the radio wave intensity included in a target period from a current time to a predetermined prior time among the plurality of radio wave intensities included in the communication history information.

3. The roadside device according to claim 1, wherein the connection processing unit is configured to disconnect communication with the vehicle-mounted equipment in a case in which a predetermined time has elapsed from start of the communication with the vehicle-mounted equipment.

4. A vehicle-mounted equipment that is mounted in a vehicle and is configured to communicate with a roadside device through a roadside antenna installed to have a lane as a communication range, the vehicle-mounted equipment comprising:
a signal receiving unit configured to receive a signal from the roadside device;
a history storing section configured to record communication history information in which roadside device identification information of the roadside device included in the signal and a radio wave intensity of the signal are associated with each other; and
a history transmitting unit configured to transmit the communication history information to the roadside device.

5. A road-to-vehicle communication system comprising:
a roadside device that is configured to communicate with a vehicle-mounted equipment mounted in a vehicle traveling in a lane through a roadside antenna installed to have the lane as a communication range, the roadside device comprising:
a history receiving unit configured to receive communication history information in which roadside device identification information that can be used for identifying a roadside device with which the vehicle-mounted equipment has communicated and a radio wave intensity in communication with the roadside device are recorded in association with each other from the vehicle-mounted equipment; and
a connection processing unit configured to continue communication with the vehicle-mounted equipment in a case in which a first radio wave intensity associated with the roadside device identification information of an own roadside device is the highest among a plurality of radio wave intensities included in the communication history information and disconnect the communication with the vehicle-mounted equipment in a case in which the first radio wave intensity is lower than a second radio wave intensity associated with the roadside device identification information of another roadside device; and
the vehicle-mounted equipment according to claim 4.

6. (canceled)

7. (canceled)

8. (canceled)
